(19) United States
(12) Patent Application Publication
(10) Pub. No.: US 2017/0313961 A1
(43) Pub. Date: Nov. 2, 2017

(54) STEAM CLEAN BOOSTER POWDER

(71) Applicant: Electrolux Home Products, Inc., Charlotte, NC (US)

(72) Inventors: Steven Swayne, Nashville, TN (US); Brendan McGinnis, Russellville, KY (US); Andrew Worley, Springfield, TN (US)

(21) Appl. No.: 15/143,795

(22) Filed: May 2, 2016

(51) Int. Cl. C11D 11/00; C11D 7/26; C11D 7/12; B08B 9/08; B08B 3/00; F24C 14/00; A21B 3/00

(52) U.S. Cl. CPC C11D 11/0041; F24C 14/005; C11D 7/265; A21B 3/006; B08B 9/0861; B08B 3/00; C11D 7/12

(57) ABSTRACT

In accordance with one aspect of the present invention, a method for cleaning a cooking chamber is provided. The method comprises applying a cleanser composition and water to the cooking chamber followed by incubating the cooking chamber. The cleanser composition comprises components that aid in loosening soil and debris during the steam cleaning and also provides a pleasant aroma. The cleanser composition aids in loosening soil and debris by effervescence.

### CROSS-REFERENCE TO RELATED APPLICATIONS

Not applicable.

### FIELD OF THE INVENTION

The following description relates generally to cleanser compositions and methods of using such compositions to aid in loosening soil and debris during a cleaning cycle of an oven, preferably a steam-clean cycle.

### BACKGROUND OF THE INVENTION

Typically, ovens that feature a “self-clean” option utilize high-temperature pyrolysis to convert baked-on soils adherent to oven-cavity surfaces to ash at temperatures that can approach 900° F. At the conclusion of the cycle, the ash can simply be wiped away. Pyrolytic cleaning cycles are effective, but come with certain risks given the very high temperatures involved. Certain other cleaning cycles that operate at lower temperatures rely on moisture to loosen soil and debris on the surface of the cooking chamber. For example, steam is generated by pouring water in the cooking chamber followed by heating the cooking chamber. Alternatively, the oven can include a steam-generating device that produces steam for the cleaning cycle. Once the cleaning cycle is complete, the remaining water and loosened soil and debris can be wiped away. However, steam-clean cycles performed without the aid of a suitable cleanser often do not provide efficient cleaning, leaving behind undesired soils. A suitable cleanser is desirable to minimize residue left behind from a steam-cleaning cycle.

### BRIEF SUMMARY OF THE INVENTION

A cleanser composition that aids in loosening soil and debris from a cooking chamber during a cleaning cycle is disclosed. The cleanser composition includes (i) at least one acid; (ii) at least one base; (iii) an optional fragrance; and (iv) an optional anti-caking agent. The cleanser composition is applied over soiled areas on the cooking chamber bottom before water is introduced to the cooking chamber. When water contacts the cleanser composition, an acid-base reaction occurs and the resulting effervescence aids in loosening soil and debris. The optional fragrance in the cleanser composition provides for a pleasant aroma compared to conventional oven steam-clean cycles.

Further, a method for cleaning a cooking chamber in an oven is disclosed. The method includes (i) applying a cleanser composition over soiled areas on a surface of the cooking chamber and (ii) incubating the cooking chamber in the presence of saturated steam for a period of time. The cleanser composition includes (i) 20-70 weight percent of at least one acid; (ii) 30-80 weight percent of at least one base; (iii) 0-4 weight percent of at least one fragrance, and (iv) 0-10 weight percent of at least one anti-caking agent.

Still further, a method of cleaning a cooking chamber in an oven having a steam-generating device is disclosed. The method includes (i) applying a cleanser composition over soiled areas of the cooking chamber; (ii) incubating the cooking chamber, and (iii) applying steam generated by the steam-generating device to the cooking chamber to facilitate an effervescent chemical reaction from the cleanser composition upon dissolution thereof in condensate from the steam. The cleanser composition includes (i) 20-70 weight percent of at least one acid; (ii) 30-80 weight percent of at least one base; (iii) 0-4 weight percent of at least one fragrance, and (iv) 0-10 weight percent of at least one anti-caking agent.

### DESCRIPTION OF EMBODIMENTS

In the description that follows when a preferred range, such as 5 to 25 (or 5-25) is given, this means preferably at least 5 and, separately and independently, preferably not more than 25.

The cleanser composition for loosening soil and debris inside a cooking chamber includes a combination of at least one acid and at least one base, and optionally one or more of a fragrance and/or anti-caking agent. The cleanser composition has the following preferred formulation as shown in Table 1. In Table 1, all values are weight percents. It is to be further understood that a cleanser composition as herein disclosed need not necessarily draw its entire composition from a single column in Table 1; such a cleanser composition may, for example, include one or some component(s) from the “preferred” column below, other component(s) from the “less preferred” column, and still other component(s) from the “still less preferred” column.

TABLE 1

| | | | | Still Less |
|---|---|---|---|---|
| | | Preferred | | Preferred |
| | Most Preferred | Weight | Less Preferred | Weight |
| Component | Weight Percent | Percent | Weight Percent | Percent |
| Acid | 32-55 | 30-60 | 25-65 | 20-70 |
| Base | 45-68 | 40-70 | 35-75 | 30-80 |
| Fragrance | 0.2-1 | 0.1-2 | 0.01-3 | 0-4 |
| Anti-caking | 1-2 | 0.1-3 | 0.01-6 | 0-10 |
| agent | | | | |

The cleanser composition provides cleaning characteristics and is preferably based on food-grade materials. Each of the components from Table 1 above will now be further described.

The acid component is provided to react with the base to effervesce and loosen soil and debris on the cooking chamber. Suitable acids to be used in the cleanser composition include solid organic, mineral, or inorganic acids, salts or derivatives thereof, including anhydrous forms or hydrates, or a mixture thereof. Preferably these acids are food-grade. It may be preferred that the acids are mono-, bi-, or tri-protonic acids. Such acids include mono- or polycarboxylic acids. Preferably, such acids include 3-ketoglutaric acid, adipic acid, ascorbic acid, citramalic acid, citric acid, fumaric acid, glutaric acid, lactic acid, maleic acid, malic acid, malonic acid, succinic acid, and tartaric acid.

The acid is preferably present in the cleanser composition in an amount of 20% to 70% by weight of the total composition, preferably from 25% to 65%, more preferably from 30% to 60% and most preferably from 32% to 55%.

In one embodiment, the cleanser composition could comprise a single acid. In another embodiment, the cleanser composition could comprise a mixture of two, three, four, or five acids, where the sum of the weights of all such acids corresponds to the weight percentages listed in Table 1 for the acid component.

The base component is provided to react with the acid to effervesce and loosen soil and debris on the cooking chamber. Preferably these bases are food-grade. The base can include carbonate salts, bicarbonate salts, percarbonate salts, phosphate salts, phosphate-substitute salts, silicate salts, or derivatives thereof, including anhydrous forms or hydrates, or a mixture thereof. Suitable carbonates to be used herein include calcium carbonate, magnesium carbonate, potassium carbonate, and sodium carbonate. Suitable bicarbonates to be used herein include potassium bicarbonate and sodium bicarbonate. Suitable percarbonates to be used herein include sodium percarbonate. Suitable phosphate salts include mono-, di-, and tri-sodium phosphate, tetrasodium pyrophosphate, and tripotassium phosphate. Suitable phosphate-substitute salts include TSP-PF sold by Savogran, which is a mixture of sodium sesquicarbonate (90% to 95% by weight), sodium metasilicate (0% to 5% by weight) and tetrasodium EDTA (0% to 5% by weight) and has a pH of 10-11 (1% in water), and PHOSPHATE FREE TSP sold by Sunnyside Corporation, which is a mixture of sodium sesquicarbonate and sodium metasilicate (80% to 100% by weight) and has a density of 0.8 g/cm³. Suitable silicates include potassium silicate and sodium metasilicate.

The base is preferably present in the cleanser composition in an amount of 30% to 80% by weight of the total composition, preferably from 35% to 75%, more preferably from 40% to 70% and most preferably from 45% to 68%.

In one embodiment, the cleanser composition could comprise a single base. In another embodiment, the cleanser composition could comprise a mixture of two, three, four, or five bases, where the sum of the weights of all such bases corresponds to the parts by weight listed in Table 1 for the base component.

Optionally, a fragrance component is included in the cleanser composition to produce a pleasant aroma as the cleanser composition is used in a steam-clean cycle in an oven. Preferably these fragrances are food-grade. The fragrance component is conventional and may comprise natural materials, synthetic aromatic agents, or a combination thereof to provide a fragrance-yielding component in a solid form for incorporation into the powder composition. The fragrance component can include flower, fruit, spice, and other scents, including cinnamon scent, citrus scent, honeysuckle scent, hibiscus scent, jasmine scent, lavender scent, lemon scent, lilac scent, orange scent, peach scent, peppermint scent, pine scent, pineapple scent, pumpkin-spice scent, strawberry scent, vanilla scent, and wintergreen scent. Other scents and fragrances which are commercially available may also be employed. The fragrance component can be a solid salt or ester compound soluble in water, that releases the associated fragrance upon vaporization of water containing the dissolved compound.

The fragrance component is preferably present in the cleanser composition in an amount of 0% to 4% by weight of the total composition, preferably from 0.01% to 3%, more preferably from 0.1% to 2% and most preferably from 0.2% to 1%.

In one embodiment, the cleanser composition could comprise a single fragrance. In another embodiment, the cleanser composition could comprise a mixture of two, three, four, or five fragrances, where the sum of the weights of all such fragrances corresponds to the parts by weight listed in Table 1 for the fragrance component.

Optionally, an anti-caking agent is included in the cleanser composition to prevent the formation of clumps (caking) in the powder cleanser composition and to improve packaging. Preferably these anti-caking agents are food-grade. The cleanser composition could comprise a wide variety of anti-caking agents, including tricalcium phosphate, powdered cellulose, magnesium stearate, sodium bicarbonate, sodium ferrocyanide, potassium ferrocyanide, sodium silicate, silicon dioxide, calcium silicate, magnesium trisilicate, talcum powder, sodium aluminosilicate, calcium aluminosilicate, bentonite, stearic acid, polydimethylsiloxane, and derivatives thereof.

The anti-caking agent is preferably present in the cleanser composition in an amount of 0% to 10% by weight of the total composition, preferably from 0.01% to 6%, more preferably from 0.1% to 3% and most preferably from 1% to 2%.

In one embodiment, the cleanser composition could comprise a single anti-caking agent. In another embodiment, the cleanser composition could comprise a mixture of two, three, four, or five anti-caking agents, where the sum of the weights of all such anti-caking agents corresponds to the parts by weight listed in Table 1 for the anti-caking agent component.

Specific exemplary cleanser compositions having desirable properties are shown in Table 2. These compositions have been found to remove substantially all of the soil and debris on the bottom of a cooking chamber when used during a steam-clean cycle.

TABLE 2

Specific Preferred
Formulations

| Component | 1 | 2 | 3 | 4 |
|---|---|---|---|---|
| Citric acid | 50 | 50 | 37.5 | 37.5 |
| Sodium carbonate | 50 | — | 37.5 | 37.5 |
| Sodium bicarbonate | — | 50 | — | — |
| Trisodium phosphate | — | — | 25 | — |
| Phosphate-substitute salt | — | — | — | 25 |

In order to improve a steam-clean cycle in an oven, the cleanser composition preferably is applied in solid-powdered form directly to a soiled area within the cooking chamber. A predetermined amount of water (i.e. two to four cups) is then supplied to the bottom of the cooking chamber. After the oven door is closed, the steam-clean cycle is initiated. The steam-clean cycle preferably is a low-temperature cycle (e.g. 150° F. to 250° F., more preferably 170° F. to 200° F., and most preferably around 180° F.) wherein heat for the cycle is generated in a conventional manner utilizing one or more heating elements as known in the art; e.g. conventional bake, broil and/or convection elements. As a result of heat generated from one or more of these elements, at least a portion of the water previously supplied to the cooking chamber of the oven is vaporized to steam and dispersed throughout the chamber. As steam contacts and condenses on soiled surfaces, particularly those where the cleanser composition has been deposited, the composition dissolves in the liquid water at the soiled surface whereupon an effervescent acid-base reaction ensues, thereby loosening and abrading deposited soils. This process continues for the duration of the steam-cleaning cycle. Thus it can be appreciated that as moisture continuously becomes vaporized, dispersed, re-deposited on cooking-chamber surfaces, and re-vaporizes, the cleanser composition assists to remove soils by improving the abrading action of the condensing and vaporizing steam, producing a stronger attack against soils. In addition, certain soils may be susceptible to chemical attack by the dissolved acid and/or base components in the steam condensate, which may also provide a chemical enhancement to facilitate soil removal by dissolving a portion of the soil that is bonded to the chamber wall via adhesion.

Lifted soil and debris from the cooking chamber may run down inner walls of the cooking chamber together with the condensed water to be drained via an appliance drain, or they may become more readily removable after being soaked by repeated cycles of condensing and vaporizing water during the cycle. When the steam-clean cycle of the oven is complete, the door is opened and the remaining water and loosened soil and debris are removed from the cooking chamber. Water and/or vinegar may then be applied to the cooking chamber to aid in removing any residual soil or debris in the cooking chamber, which should now be less-strongly adhered to cooking-chamber walls as a result of the cycle.

In another embodiment, rather than pouring water into the base of the cooking chamber the water can be supplied to a water reservoir of an onboard steam-generation unit, which will supply the steam during the cleaning cycle. Such a reservoir can be one within the cooking chamber itself that relies on a heating element, e.g. a hidden-bake element under the cooking chamber bottom wall to vaporize water to steam. Alternatively, steam can be supplied for the cycle via a dedicated steam-generation system that is configured to generate and supply steam to the cooking chamber, for example during a steam-bake cycle. For cooking appliances equipped with such a steam-generation system for cooking cycles, that system can be relied upon during the aforementioned steam-clean cycle to supply the steam to the cooking chamber to solvate the cleansing composition and generate the ensuing effervescent acid-base reaction, thereby loosening and lifting soils as above described.

Regardless of the mode of steam generation for the cycle, it is generally preferable that there be sufficient moisture in the cooking chamber to ensure that the relative humidity within that chamber at the prevailing chamber temperature during the cycle is 100%. For example, during a preferred steam-cleaning cycle operating at 150 to 190° F., there should be sufficient moisture within the chamber to ensure that steam fully saturates the vapor-space within the chamber. This means that ideally there will be at all times during the cycle excess liquid water within the chamber to ensure a fully-saturated steam-vapor condition. An exemplary cycle will operate at the desired steam-clean cycle temperature (or temperature range, as described herein) for 30 to 180 minutes; more preferably 30 to 90 minutes; and most preferably 30 to 60 minutes. After an appropriate incubation period at the temperature and during the time period as described herein, the oven door is opened and any residual water and loosened soil and debris are removed from the cooking chamber, e.g. using a sponge and optionally mild solvent. For example, solvents such as water and/or vinegar may be applied to the cooking chamber to aid in removing any residual soil or debris following the steam-clean cycle.

### EXAMPLES

The examples in the following table further illustrate various aspects of the disclosed cleanser composition. In the following examples, all composition data are given as weight percents for the specified component based on the total composition for each example.

Examples

| Component | 1 | 2 |
|---|---|---|
| citric acid | 50 | 50 |
| sodium carbonate | — | 50 |
| sodium bicarbonate | 50 | — |

The performance of example cleanser compositions to aid in loosening soil and debris on a cooking chamber surface in a consumer oven was evaluated by the following methods. Two tablespoons of the cleanser composition of Example 1 were applied directly to a soil at the bottom of an oven cooking chamber. Four cups of water were then applied to the bottom of the cooking chamber. The oven door was then closed and the cooking chamber was incubated at a temperature of 190° F. for 60 minutes. After the incubation period, the cooking chamber was allowed to cool to room temperature. The oven door was opened after the clean cycle was complete. The remaining water and loosened soil and debris were removed with a dry paper towel. Water and vinegar were then applied to the surface of the cooking chamber to aid in removing any residual soil or debris in the cooking chamber. The cleanser composition of Example 1 was found to have removed substantially all of the soil and debris on the bottom of the cooking chamber according to this procedure.

Two tablespoons of the cleanser composition of Example 2 were applied directly to a soil at the bottom of an oven cooking chamber. Two cups of water were then applied to the bottom of the cooking chamber. The oven door was then closed and the cooking chamber was incubated at a temperature of 190° F. for 30 minutes. After the incubation period, the cooking chamber was allowed to cool for 10 minutes. The oven door was opened after the clean cycle was complete. The remaining water and loosened soil and debris were removed with a dry paper towel. Water and vinegar were then applied to the surface of the cooking chamber to aid in removing any residual soil or debris in the cooking chamber. The cleanser composition of Example 2 was found to have removed substantially all of the soil and debris on the bottom of the cooking chamber according to this procedure.

Illustrative embodiments have been described, hereinabove. It will be apparent to those skilled in the art that the above apparatuses and methods may incorporate changes and modifications without departing from the scope of this disclosure. The invention is therefore not limited to particular details of this disclosure, and will encompass modifications and adaptions thereof within the spirit and the scope of the appended claims.

1. A method for cleaning a cooking chamber of an oven, comprising:
applying a cleanser composition to a soiled area on a surface of the cooking chamber and incubating the cooking chamber in the presence of saturated steam for a period of time;
said cleanser composition comprising 20-70 weight percent of at least one acid, 35-50 weight percent of sodium carbonate, 0-4 weight percent of at least one fragrance, and 0-10 weight percent of at least one anti-caking agent.

2. The method of claim 1, the at least one acid being selected from 3-ketoglutaric acid, adipic acid, ascorbic acid, citramalic acid, citric acid, fumaric acid, glutaric acid, lactic acid, maleic acid, malic acid, malonic acid, succinic acid, tartaric acid, derivatives thereof and mixtures thereof.

3. The method of claim 1, further comprising at least one base being selected from calcium carbonate, magnesium carbonate, potassium carbonate, potassium bicarbonate, sodium bicarbonate, sodium percarbonate, monosodium phosphate, disodium phosphate, trisodium phosphate, tetrasodium pyrophosphate, tripotassium phosphate, phosphate-substitute salts, potassium silicate, sodium metasilicate, derivatives thereof and mixtures thereof.

4. The method of claim 1, the at least one fragrance being selected from natural material fragrances and synthetic aromatic agents.

5. The method of claim 1, the at least one anti-caking agent being selected from tricalcium phosphate, powdered cellulose, magnesium stearate, sodium bicarbonate, sodium ferrocyanide, potassium ferrocyanide, sodium silicate, silicon dioxide, calcium silicate, magnesium trisilicate, talcum powder, sodium aluminosilicate, calcium aluminosilicate, bentonite, stearic acid, polydimethylsiloxane, and derivatives thereof.

6. The method of claim 3, the at least one acid being citric acid and the at least one base being trisodium phosphate.

7. The method of claim 6, said cleanser composition comprising 37.5 weight percent citric acid, 37.5 weight percent sodium carbonate, and 25 weight percent trisodium phosphate.

8. (canceled)

9. The method of claim 1, said cleanser composition comprising 50 weight percent citric acid and 50 weight percent sodium carbonate.

10. The method of claim 6, said cleanser composition being applied to said soiled area in solid powder form.

11. The method of claim 10, said chamber being incubated at 150 to 200° F. for a time period of 30 to 180 minutes, said chamber being thereafter opened so that residual, loosened soils can be removed.

12. A method for cleaning a cooking chamber of an oven having a steam-generating device, comprising:
applying a cleanser composition to a soiled area of a cooking chamber;
incubating the cooking chamber; and
applying steam generated by the steam-generating device to the cooking chamber to facilitate an effervescent chemical reaction from said cleanser composition upon dissolution thereof in condensate from said steam;
said cleanser composition comprising 20-70 weight percent of at least one acid, 35-50 weight percent of sodium carbonate, 0-4 weight percent of at least one fragrance, and 0-10 weight percent of at least one anti-caking agent.

13. The method of claim 12, the at least one acid being selected from 3-ketoglutaric acid, adipic acid, ascorbic acid, citramalic acid, citric acid, fumaric acid, glutaric acid, lactic acid, maleic acid, malic acid, malonic acid, succinic acid, tartaric acid, derivatives thereof and mixtures thereof.

14. The method of claim 12, further comprising at least one base being selected from calcium carbonate, magnesium carbonate, potassium carbonate, potassium bicarbonate, sodium bicarbonate, sodium percarbonate, monosodium phosphate, disodium phosphate, trisodium phosphate, tetrasodium pyrophosphate, tripotassium phosphate, phosphate-substitute salts, potassium silicate, sodium metasilicate, derivatives thereof and mixtures thereof.

15. The method of claim 12, the at least one fragrance being selected from natural material fragrances and synthetic aromatic agents.

16. The method for cleaning a cooking chamber of an oven according to claim 12, the at least one anti-caking agent being selected from tricalcium phosphate, powdered cellulose, magnesium stearate, sodium bicarbonate, sodium ferrocyanide, potassium ferrocyanide, sodium silicate, silicon dioxide, calcium silicate, magnesium trisilicate, talcum powder, sodium aluminosilicate, calcium aluminosilicate, bentonite, stearic acid, polydimethylsiloxane, derivatives thereof and mixtures thereof.

17. The method of claim 14, the at least one acid being citric acid and the at least one base being trisodium phosphate.

18. The method of claim 17, said cleanser comprising 37.5 weight percent citric acid, 37.5 weight percent sodium carbonate, and 25 weight percent trisodium phosphate.

19. The method of claim 17, said cleanser composition being applied to said soiled area in solid powder form.

20. The method of claim 19, said chamber being incubated at 150 to 200° F. for a time period of 30 to 180 minutes, said chamber being thereafter opened so that residual, loosened soils can be removed.

21. The method of claim 12, the steam-generating device being an onboard steam-generation unit or one or more heating elements for the chamber.

22. (canceled)

23. The method of claim 12, said cleanser composition comprising 50 weight percent citric acid and 50 weight percent sodium carbonate.
